(19) United States
(12) Patent Application Publication
(10) Pub. No.: US 2023/0019167 A1
(43) Pub. Date: Jan. 19, 2023

(54) DRIVING METHOD, DRIVING CIRCUITRY AND DRIVING DEVICE FOR TOUCH DISPLAY SUBSTRATE, AND DISPLAY DEVICE

(71) Applicants: Beijing BOE Display Technology Co., Ltd., Beijing (CN); BOE Technology Group Co., Ltd., Beijing (CN)

(72) Inventors: Pengfei HU, Beijing (CN); Yinlong ZHANG, Beijing (CN); Zhihua SUN, Beijing (CN); Shulin YAO, Beijing (CN); Wenpeng MA, Beijing (CN); Qi LI, Beijing (CN); Yanping LIAO, Beijing (CN); Xibin SHAO, Beijing (CN)

(21) Appl. No.: 17/787,688

(22) PCT Filed: Aug. 12, 2021
(86) PCT No.: PCT/CN2021/112232

§ 371 Date: Jun. 21, 2022

(30) Foreign Application Priority Data
Sep. 21, 2020 (CN) 202010994455.5

(51) Int. Cl. G06F 3/041

(52) U.S. Cl. CPC G06F 3/04166

(57) ABSTRACT

The present disclosure provides a driving method, a driving circuitry and a driving device for a touch display substrate, and a display device, and relates to the field of touch display technology. The driving method for the touch display substrate, includes: detecting a touch signal in one or more first time periods during which the touch display substrate operates, and a second time period being arranged between adjacent first time periods; reducing frame refreshing frequency of the touch display substrate, in response to detecting the touch signal in the one or more first time periods; and keeping the frame refreshing frequency of the touch display substrate unchanged, in response to detecting no touch signal in the one or more first time periods. According to the technical schemes of the present disclosure, it is able to ensure the touch effect of the touch display substrate.

### CROSS-REFERENCE TO RELATED APPLICATION

This application claims a priority of the Chinese patent application No. 202010994455.5 filed on Sep. 21, 2020, which is incorporated herein by reference in its entirety.

### TECHNICAL FIELD

The present disclosure relates to the field of display technology, in particular to a driving method for a touch display substrate, a driving circuitry for a touch display substrate, a driving device for a touch display substrate, and a display device.

### BACKGROUND

Touch principle of existing touch display substrate is as follows: a touch signal is obtained in a high level continuous phase of a touch enable signal (Touch EN) and is fed back to a System on Chip (SOC) through a Microcontroller Unit (MCU). Further, the SOC adds information about one touch point to a current display frame and displays the information about the touch point in a low level continuous phase of the Touch EN, and information about a next touch point is obtained in a next high level continuous phase of the Touch EN, so as to cycle back and forth to implement the touch.

### SUMMARY

An object of the present disclosure is to provide a driving method for a touch display substrate, a driving circuitry for a touch display substrate, a driving device for a touch display substrate, and a display device, so as to ensure the touch effect of the touch display substrate.

The present disclosure provides the following technical solutions.

In one aspect, the present disclosure provides in some embodiments a driving method for a touch display substrate, including detecting a touch signal in one or more first time periods during which the touch display substrate operates, and a second time period being arranged between adjacent first time periods; reducing frame refreshing frequency of the touch display substrate, in response to detecting the touch signal in the one or more first time periods; or keeping the frame refreshing frequency of the touch display substrate unchanged, in response to detecting no touch signal in the one or more first time periods.

In some possible embodiments of the present disclosure, in response to detecting the touch signal in the one or more first time periods, the driving method further includes: detecting the touch signal continuously in the second time period after a corresponding first time period among the one or more first time periods.

In some possible embodiments of the present disclosure, an operation time period of the touch display substrate includes one or more display phases for displaying respective frames and one or more blank phases between corresponding display phases of adjacent frames, the one or more first time periods coincides with the one or more blank phases, and the one or more second time periods coincides with the one or more display phases.

In some possible embodiments of the present disclosure, in response to detecting the touch signal in the one or more first time periods, subsequence to reducing the frame refreshing frequency of the touch display substrate, the driving method further includes: returning the frame refreshing frequency of the touch display substrate to normal, in response to detecting no touch signal in N consecutive first time periods after the first time period in which the touch signal is detected, where N is a positive integer.

In some possible embodiments of the present disclosure, prior to reducing the frame refreshing frequency of the touch display substrate, the frame refreshing frequency of the touch display substrate is 120 Hz; and subsequence to reducing the frame refreshing frequency of the touch display substrate, the frame refreshing frequency of the touch display substrate is 60 Hz.

In some possible embodiments of the present disclosure, the detecting the touch signal in the one or more first time periods during which the touch display substrate operates includes: setting a Touch EN to a high level within the one or more first time periods, and setting the Touch EN to a low level not within the one or more first time periods.

In another aspect, the present disclosure provides in some embodiments a driving circuitry for a touch display substrate, including a detection unit, configured to detect a touch signal in one or more first time periods during which the touch display substrate operates, and a second time period being arranged between adjacent first time periods; and a processing unit, configured to reduce frame refreshing frequency of the touch display substrate, in response to detecting the touch signal in the one or more first time periods; or to keep the frame refreshing frequency of the touch display substrate unchanged, in response to detecting no touch signal in the one or more first time periods.

In some possible embodiments of the present disclosure, in response to detecting the touch signal in the one or more first time periods, the detection unit is further configured to detect the touch signal continuously in the second time period after a corresponding first time period among the one or more first time periods.

In some possible embodiments of the present disclosure, an operation time period of the touch display substrate includes one or more display phases for displaying respective frames and one or more blank phases between corresponding display phases of adjacent frames, the one or more first time periods coincides with the one or more blank phases, and the one or more second time periods coincides with the one or more display phases.

In some possible embodiments of the present disclosure, the processing unit is further configured to return the frame refreshing frequency of the touch display substrate to normal, in response to detecting no touch signal in N consecutive first time periods after the first time period in which the touch signal is detected, where N is a positive integer.

In some possible embodiments of the present disclosure, prior to reducing the frame refreshing frequency of the touch display substrate, the frame refreshing frequency of the touch display substrate is 120 Hz; and subsequence to reducing the frame refreshing frequency of the touch display substrate, the frame refreshing frequency of the touch display substrate is 60 Hz.

In some possible embodiments of the present disclosure, the detection unit is specifically configured to set a Touch EN to a high level within the one or more first time periods, and set the Touch EN to a low level not within the one or more first time periods.

In yet another aspect, the present disclosure provides in some embodiments a display device, including the above-mentioned driving circuitry for the touch display substrate.

In still yet another aspect, the present disclosure provides in some embodiments a driving device for a touch display substrate, including a processor; and a memory storing therein instructions. The memory is configured to implement the above-mentioned driving method when the instructions are executed by the processor.

In still yet another aspect, the present disclosure provides in some embodiments a storage medium storing therein instructions, and the memory is configured to implement the above-mentioned driving method when the instructions are executed by a processor.

### BRIEF DESCRIPTION OF THE DRAWINGS

FIG. 1 is a signal sequence diagram of a touch display substrate in the related art;

FIG. 2 is a flow chart of a driving method for a touch display substrate according to one embodiment of the present disclosure;

FIG. 3 is a signal sequence diagram of the driving method for the touch display substrate when there is no touch according to one embodiment of the present disclosure;

FIG. 4 is a signal sequence diagram of the driving method for the touch display substrate when touch exists according to one embodiment of the present disclosure;

FIG. 5 is a schematic view showing a driving circuitry of the touch display substrate according to one embodiment of the present disclosure; and

FIG. 6 is a schematic view showing a driving device for the touch display substrate according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments.

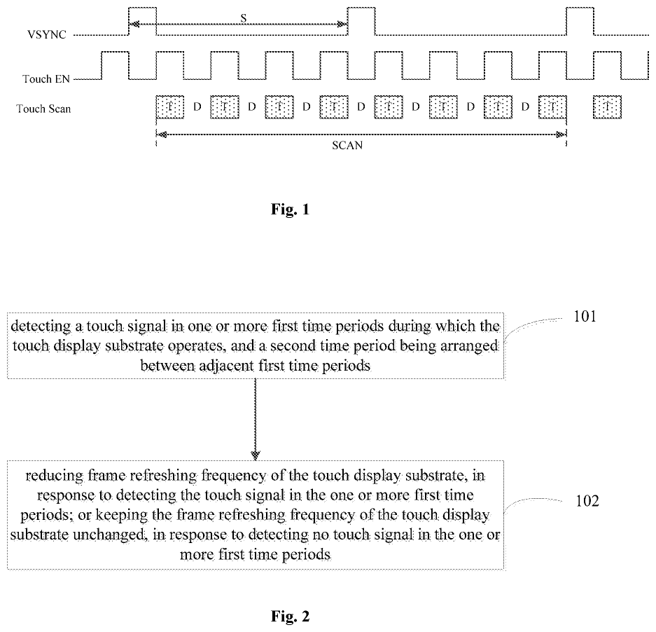

Touch principle of a touch display substrate is as follows: a touch signal is obtained in a high level continuous phase of a Touch EN and is fed back to a System On Chip (SOC) through a Microcontroller Unit (MCU), the SOC processes the touch signal to obtain information about one touch point, adds the information about the touch point to a current display frame and displays the information about the touch point in a low level continuous phase of the Touch EN, and information about a next touch point is obtained in a next high level continuous phase of the Touch EN, so as to repeat the above cycle to implement the touch sensing. As shown in FIG. 1, VSYNC represents a synchronization signal, Touch Scan represents a touch scanning signal, a touch driving signal is transmitted in phase T, the touch signal is received in phase D, touch detection is performed in phase SCAN, and S represents display duration of one frame.

In the touch display substrate, high level duration of the Touch EN and low level duration of the Touch EN are in proportional to display time of respective frames, and with the increase of refreshing frequency of the touch display substrate, the high level duration of the Touch EN and the low level duration of the Touch EN becomes extremely short at 120 Hz or higher refreshing frequency. The touch signal received in the high level duration of the Touch EN may not be fed back to the touch display substrate for displaying in time after being processed by the SOC, interruption will occur during continuous touch, and complete continuous touch effect may not be implemented.

The present disclosure provides in some embodiments a driving method for a touch display substrate, a driving circuitry for a touch display substrate, a driving device for a touch display substrate, and a display device, so as to ensure the touch effect of the touch display substrate.

The present disclosure provides in some embodiments a driving method for a touch display substrate which, as shown in FIG. 2, includes Step 101 of detecting a touch signal in one or more first time periods during which the touch display substrate operates, and a second time period being arranged between adjacent first time periods; and Step 102 of reducing frame refreshing frequency of the touch display substrate, in response to detecting the touch signal in the one or more first time periods; or keeping the frame refreshing frequency of the touch display substrate unchanged, in response to detecting no touch signal in the one or more first time periods.

In the embodiments of the present disclosure, a touch signal in one or more first time periods is detected during which the touch display substrate operates, the frame refreshing frequency of the touch display substrate is reduced, in response to detecting the touch signal in the one or more first time periods; and the frame refreshing frequency of the touch display substrate is kept unchanged, in response to detecting no touch signal in the one or more first time periods. Based on this, when the touch signal is detected, it is able to prolong touch detection time, such as the high level duration of the Touch EN and the low level duration of the Touch EN, through reducing the frame refreshing frequency of the touch display substrate, the touch signal received in the high level duration of the Touch EN may be fed back to the touch display substrate for displaying in time after being processed by the SOC, interruption will not occur during the continuous touch, and complete continuous touch effect may be implemented. When a touch signal is not detected, the frame refreshing frequency of the touch display substrate is kept unchanged, the displaying of the touch display substrate is not affected, and smooth displaying may be achieved at a high frame refreshing frequency. According to the technical schemes in the embodiments of the present disclosure, there is no need to change hardware, and merely driving algorithm needs to be changed, thereby to achieve low cost and improve the competitiveness of the products effectively.

In the embodiments of the present disclosure, in response to detecting the touch signal in the one or more first time periods, the driving method further includes: detecting the touch signal continuously in the second time period after a corresponding first time period among the one or more first time periods.

In the embodiments of the present disclosure, in response to detecting no touch signal in one first time period, such as the i^{th} first time period, detecting the touch signal is performed continuously in the (i+1)^{th} first time period, the (i+2)^{th} first time period, . . . after the i^{th} first time period, where i is a positive integer; in response to detecting no touch signal continuously, detecting the touch signal is not performed in the second time period between the i^{th} first time period and the (i+1)^{th} first time period, the second time period between the (i+1)^{th} first time period and the (i+2)^{th} first time period, . . . , so as to reduce the quantity of calculation and processing. In response to detecting the touch signal in one first time period, such as the i^{th} first time period, detecting the touch signal is performed in the second time period between the i^{th} first time period and the (i+1)^{th} first time period, so as to detect the continuous touch accurately.

In the embodiments of the present disclosure, an operation time period of the touch display substrate includes one or more display phases for displaying respective frames and one or more blank phases between corresponding display phases of adjacent frames, the one or more first time periods coincides with the one or more blank phases, and the one or more second time periods coincides with the one or more display phases. Based on this, the frame refreshing frequency is adjusted in the one or more blank phases and the display of the touch display substrate is not affected. The one or more first time periods is not limited to coincide with the one or more blank phases, and may also coincide with part of the one or more blank phases; or the one or more blank phases is arranged within the one or more first time periods, and the one or more first time periods further includes the one or more parts not within the one or more blank phases.

In the embodiments of the present disclosure, the detecting the touch signal in the one or more first time periods during which the touch display substrate operates may include: setting the Touch EN to a high level within the one or more first time periods, and setting the Touch EN to a low level not within the one or more first time periods.

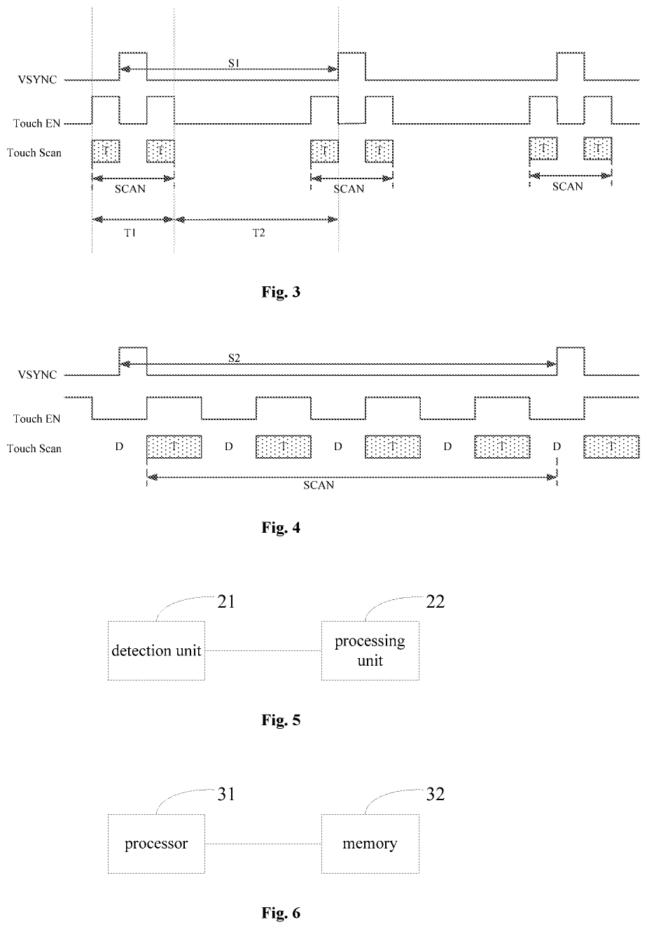

In the embodiments of the present disclosure, in the case that the frame refreshing frequency of the touch display substrate is at a high refreshing frequency, such as a first refreshing frequency, as shown in FIG. 3, when there is no touch, the Touch EN is merely at a high level within the one or more blank phases, and is at a low level not within the one or more blank phases. At this time, the Touch EN merely achieves the touch detection function, S1 represents display duration of one frame, SCAN represents touch detection phase, the touch driving signal is transmitted in phase T, and the touch signal is received in phase D. In the embodiments of the present disclosure, the one or more blank phases coincides with the one or more first time periods T1, the one or more display phases coincides with the one or more second time periods T2. When a touch occurs, the Touch EN obtains the touch signal at the high level, and the touch signal is fed back to the SOC for mode switching. At this time, the frame refreshing frequency of the touch display substrate is reduced to a second refreshing frequency by the SOC, and the second refreshing frequency is less than the first refreshing frequency. As shown in FIG. 4, S2 represents the display duration of one frame, SCAN represents the touch detection phase, S2 is greater than S1, the touch driving signal is transmitted in phase T, and the touch signal is received in phase D. At the same time, the Touch EN is set to the high level to detect the continuous touch; as the frame refreshing frequency is reduced, the time for setting the Touch EN to be at the high level is prolonged, so that the touch signal received in the high level duration of the Touch EN may be fed back to the touch display substrate for displaying in time after being processed by the SOC, interruption will not occur during the continuous touch, and complete continuous touch effect may be implemented.

In the embodiments of the present disclosure, prior to reducing the frame refreshing frequency of the touch display substrate, the frame refreshing frequency of the touch display substrate may be 120 Hz, i.e., the first refreshing frequency is 120 Hz; and subsequence to reducing the frame refreshing frequency of the touch display substrate, the frame refreshing frequency of the touch display substrate is 60 Hz, i.e., the second refreshing frequency may be 60 Hz. Of course, the value of the first refreshing frequency is not limited to 120 Hz, the value of the second refreshing frequency is not limited to 60 Hz, and the value of the first refreshing frequency and the value of the second refreshing frequency may be set to other values as required.

In the embodiments of the present disclosure, in response to detecting the touch signal in the one or more first time periods, subsequence to reducing the frame refreshing frequency of the touch display substrate, the driving method further includes: returning the frame refreshing frequency of the touch display substrate to normal, in response to detecting no touch signal in N consecutive first time periods after the first time period in which the touch signal is detected, where N is a positive integer.

In the embodiments of the present disclosure, in response to detecting the touch signal in one first time period, such as the i^{th} first time period, detecting the touch signal is performed continuously in the second time period between the i^{th} first time period and the (i+1)^{th} first time period to detect the continuous touch accurately, and the detecting the touch signal is performed continuously in the (i+1)^{th} first time period, the (i+2)^{th} first time period, . . . after the i^{th} first time period, in response to detecting no touch signal in the (i+j)^{th} first time period, it is able to return the frame refreshing frequency of the touch display substrate to normal immediately in the second time period after the (i+j)^{th} first time period to ensure the smoothness of normal display; or the frame refreshing frequency of the touch display substrate may not be returned to normal temporarily, it is able to detect the touch signal in the plurality of first time periods, i.e., the above-mentioned N consecutive time periods, after the (i+j)^{th} first time period continuously, until no touch signal is detected in the plurality of first time periods, the frame refreshing frequency of the touch display substrate is returned to normal to ensure the smoothness of normal display, thereby to avoid frequent switching of the frame refreshing frequency.

During the frame refreshing frequency of the touch display substrate being returning to normal, the frame refreshing frequency is still fed back to the SOC for mode switching, and the SOC increases the frame refreshing frequency of the touch display substrate to the first refreshing frequency, e.g., 120 Hz, thereby to achieve smooth display without touching.

In the embodiments of the present disclosure, there is no need to change the hardware of the touch display substrate, and merely the driving algorithm needs to be optimized, and merely the driving algorithm needs to be optimized to generate the required timing sequence, so as to effectively solve the problem of interruption of continuous touch on a TV or other large-sized touch screens.

In the embodiments of the present disclosure, the touch signal is obtained when the Touch EN is at the high level. However, the technical schemes in the embodiments is not limited to obtaining the touch signal when the Touch EN is at the high level, but also obtaining the touch signal when the Touch EN is at the low level.

The present disclosure further provides in some embodiments a driving circuitry for a touch display substrate which, as shown in FIG. 5, includes a detection unit 21, configured to detect a touch signal in one or more first time periods during which the touch display substrate operates, and a second time period being arranged between adjacent first time periods; and a processing unit 22, configured to reduce frame refreshing frequency of the touch display substrate, in response to detecting the touch signal in the one or more first time periods; or keep the frame refreshing frequency of the touch display substrate unchanged, in response to detecting no touch signal in the one or more first time periods.

In the embodiments of the present disclosure, a touch signal in one or more first time periods is detected during which the touch display substrate operates, the frame refreshing frequency of the touch display substrate is reduced, in response to detecting the touch signal in the one or more first time periods; and the frame refreshing frequency of the touch display substrate is kept unchanged, in response to detecting no touch signal in the one or more first time periods. Based on this, when the touch signal is detected, it is able to prolong touch detection time, such as the high level duration of the Touch EN and the low level duration of the Touch EN, through reducing the frame refreshing frequency of the touch display substrate, the touch signal received in the high level duration of the Touch EN may be fed back to the touch display substrate for displaying in time after being processed by the SOC, interruption will not occur during the continuous touch, and complete continuous touch effect may be implemented. When a touch signal is not detected, the frame refreshing frequency of the touch display substrate is kept unchanged, the displaying of the touch display substrate is not affected, and smooth displaying may be achieved at a high frame refreshing frequency. According to the technical schemes in the embodiments of the present disclosure, there is no need to change hardware, and merely driving algorithm needs to be changed, thereby to achieve low cost and improve the competitiveness of the products effectively.

In the embodiments of the present disclosure, in response to detecting the touch signal in the one or more first time periods, the detection unit 21 is further configured to detect the touch signal continuously in the second time period after a corresponding first time period among the one or more first time periods.

In the embodiments of the present disclosure, in response to detecting no touch signal in one first time period, such as the i^{th} first time period, detecting the touch signal is performed continuously in the (i+1)^{th} first time period, the (i+2)^{th} first time period, . . . after the i^{th} first time period, where i is a positive integer; in response to detecting no touch signal continuously, detecting the touch signal is not performed in the second time period between the i^{th} first time period and the (i+1)^{th} first time period, the second time period between the (i+1)^{th} first time period and the (i+2)^{th} first time period, . . . , so as to reduce the quantity of calculation and processing. In response to detecting the touch signal in one first time period, such as the i^{th} first time period, detecting the touch signal is performed in the second time period between the i^{th} first time period and the (i+1)^{th} first time period, so as to detect the continuous touch accurately.

In the embodiments of the present disclosure, an operation time period of the touch display substrate includes one or more display phases for displaying respective frames and one or more blank phases between corresponding display phases of adjacent frames, the one or more first time periods coincides with the one or more blank phases, and the one or more second time periods coincides with the one or more display phases. Based on this, the frame refreshing frequency is adjusted in the one or more blank phases and the display of the touch display substrate is not affected.

In the embodiments of the present disclosure, the detection unit 21 is specifically configured to set the Touch EN to a high level within the one or more first time periods, and set the Touch EN to a low level not within the one or more first time periods.

In the embodiments of the present disclosure, in the case that the frame refreshing frequency of the touch display substrate is at a high refreshing frequency, such as a first refreshing frequency, as shown in FIG. 3, when there is no touch, the Touch EN is merely at a high level within the one or more blank phases, and is at a low level not within the one or more blank phases. At this time, the Touch EN merely achieves the touch detection function, S1 represents display duration of one frame, SCAN represents touch detection phase, the touch driving signal is transmitted in phase T, and the touch signal is received in phase D. In the embodiments of the present disclosure, the one or more blank phases coincides with the one or more first time periods T1, the one or more display phases coincides with the one or more second time periods T2.

When a touch occurs, the Touch EN obtains the touch signal at the high level, and the touch signal is fed back to the SOC for mode switching. At this time, the frame refreshing frequency of the touch display substrate is reduced to a second refreshing frequency by the SOC, and the second refreshing frequency is less than the first refreshing frequency. As shown in FIG. 4, S2 represents the display duration of one frame, SCAN represents the touch detection phase, S2 is greater than S1, the touch driving signal is transmitted in phase T, and the touch signal is received in phase D. At the same time, the Touch EN is set to the high level to detect the continuous touch; as the frame refreshing frequency is reduced, the time for setting the Touch EN to be at the high level is prolonged, so that the touch signal received in the high level duration of the Touch EN may be fed back to the touch display substrate for displaying in time after being processed by the SOC, interruption will not occur during the continuous touch, and complete continuous touch effect may be implemented.

In the embodiments of the present disclosure, prior to reducing the frame refreshing frequency of the touch display substrate, the frame refreshing frequency of the touch display substrate may be 120 Hz, i.e., the first refreshing frequency is 120 Hz; and subsequence to reducing the frame refreshing frequency of the touch display substrate, the frame refreshing frequency of the touch display substrate is 60 Hz, i.e., the second refreshing frequency may be 60 Hz. Of course, the value of the first refreshing frequency is not limited to 120 Hz, the value of the second refreshing frequency is not limited to 60 Hz, and the value of the first refreshing frequency and the value of the second refreshing frequency may be set to other values as required.

In the embodiments of the present disclosure, the processing unit 22 is further configured to return the frame refreshing frequency of the touch display substrate to normal, in response to detecting no touch signal in N consecutive first time periods after the first time period in which the touch signal is detected, where N is a positive integer.

In the embodiments of the present disclosure, in response to detecting the touch signal in one first time period, such as the i^{th} first time period, detecting the touch signal is performed continuously in the second time period between the i^{th} first time period and the (i+1)^{th} first time period to detect the continuous touch accurately, and the detecting the touch signal is performed continuously in the (i+1)^{th} first time period, the (i+2)^{th} first time period, . . . after the i^{th} first time period, in response to detecting no touch signal in the (i+j)^{th} first time period, it is able to return the frame refreshing frequency of the touch display substrate to normal immediately in the second time period after the (i+j)^{th} first time period to ensure the smoothness of normal display; or the frame refreshing frequency of the touch display substrate may not be returned to normal temporarily, it is able to detect the touch signal in the plurality of first time periods after the (i+j)^{th} first time period continuously, until no touch signal is detected in the plurality of first time periods, the frame refreshing frequency of the touch display substrate is returned to normal to ensure the smoothness of normal display, thereby to avoid frequent switching of the frame refreshing frequency.

During the frame refreshing frequency of the touch display substrate being returning to normal, the frame refreshing frequency is still fed back to the SOC for mode switching, and the SOC increases the frame refreshing frequency of the touch display substrate to the first refreshing frequency, e.g., 120 Hz, thereby to achieve smooth display without touching.

In the embodiments of the present disclosure, there is no need to change the hardware of the touch display substrate, and merely the driving algorithm needs to be optimized, and merely the driving algorithm needs to be optimized to generate the required timing sequence, so as to effectively solve the problem of interruption of continuous touch on a TV or other large-sized touch screens.

The present disclosure further provides in some embodiments a display device, including the above-mentioned driving circuitry for the touch display substrate.

The display device includes, but not limited to, a radio frequency unit, a network module, an audio output unit, an input unit, a sensor, a display unit, a user input unit, an interface unit, a memory, a processor, and a power source. It should be appreciated that, the display device may not be limited thereto, i.e., it may include more or fewer members, or some members may be combined, or the members may be arranged in different modes. In the embodiments of the present disclosure, the display device may include, but not limited to, display, mobile phone, flat-panel computer, television, wearable electronic device or navigator.

The display device may be any product or member having a display function, such as a television, a display, a digital photo frame, a mobile phone and a tablet computer. The display device further includes a flexible circuit board, a printed circuit board and a back plate.

The present disclosure further provides in some embodiments a driving device for a touch display substrate which, as shown in FIG. 6, includes a processor 31; and a memory 32 storing therein instructions. The memory 32 is configured to implement the above-mentioned driving method when the instructions are executed by the processor 31, and thus will not be particularly defined herein.

The processor 31 may be a processor or a general term for a plurality of processing elements. For example, the processor may be a Central Processing Unit (CPU), an Application Specific Integrated Circuit (ASIC), or one or more integrated circuits configured to implement the above methods, such as one or more Digital Signal Processors (DSPs), or one or more Field Programmable Gate Arrays (FPGAs); and the storage element may be a memory or a general term for a plurality of storage elements.

The memory 32 may be a volatile memory or a non-volatile memory, or may include both the volatile memory and the non-volatile memory. The non-volatile memory may be a Read-Only Memory (ROM), a Programmable ROM (PROM), an Erasable prom (EPROM), an Electrically EPROM (EEPROM) or a flash memory. The volatile memory may be a Random Access Memory (RAM), which is used as an external cache. By way of example and not limitation, many form of RAMs are available such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchronous-Link DRAM (SLDRAM) and a Direct Rambus RAM (DRRAM). The memory 32 in the embodiments of the present disclosure includes, but not limited to, the above and any other suitable types of memory.

In the embodiments of the present disclosure, the processor 31 is configured to detect a touch signal in one or more first time periods during which the touch display substrate operates, and a second time period being arranged between adjacent first time periods; reduce frame refreshing frequency of the touch display substrate, in response to detecting the touch signal in the one or more first time periods; or keep the frame refreshing frequency of the touch display substrate unchanged, in response to detecting no touch signal in the one or more first time periods.

In the embodiments of the present disclosure, the processor 31 is further configured to detect the touch signal continuously in the second time period after a corresponding first time period among the one or more first time periods.

In the embodiments of the present disclosure, an operation time period of the touch display substrate includes one or more display phases for displaying respective frames and one or more blank phases between corresponding display phases of adjacent frames, the one or more first time periods coincides with the one or more blank phases, and the one or more second time periods coincides with the one or more display phases.

In the embodiments of the present disclosure, the processor 31 is further configured to return the frame refreshing frequency of the touch display substrate to normal, in response to detecting no touch signal in N consecutive first time periods after the first time period in which the touch signal is detected, where N is a positive integer.

In the embodiments of the present disclosure, prior to reducing the frame refreshing frequency of the touch display substrate, the frame refreshing frequency of the touch display substrate is 120 Hz; and subsequence to reducing the frame refreshing frequency of the touch display substrate, the frame refreshing frequency of the touch display substrate is 60 Hz.

In the embodiments of the present disclosure, the processor 31 is specifically configured to set a Touch EN to a high level within the one or more first time periods, and set the Touch EN to a low level not within the one or more first time periods.

The present disclosure further provides in some embodiments a storage medium storing therein instructions, and the memory is configured to implement the above-mentioned driving method when the instructions are executed by the processor, and thus will not be particularly defined herein.

The storage medium includes a computer-readable storage medium, such as a computer ROM, a RAM, a magnetic disk or an optical disk.

It should be appreciated that, such word as “include” or “including” or any other variations involved in the present disclosure intend to provide non-exclusive coverage, so that a procedure, method, article or device including a series of elements may also include any other elements not listed herein, or may include any inherent elements of the procedure, method, article or device. If without any further limitations, for the elements defined by such sentence as “including one . . . ”, it is not excluded that the procedure, method, article or device including the elements may also include any other identical elements. It should be further appreciated that, the scope of the methods and devices in the embodiments of the present disclosure is not limited to performing the functions in the order shown or discussed, but also including performing the functions in a basically simultaneous manner or in a reverse order in accordance with the functions involved. For example, the described methods may be performed in a different order from the described order, and various steps may be added, omitted, or combined. In addition, features described with reference to some embodiments may be combined in other embodiments.

Through the above description, a person skilled in the art may clearly understand that the methods in the above embodiments may be implemented by means of software and a necessary general hardware platform. Based on this, the technical solutions of the present disclosure, partial or full, or parts of the technical solutions of the present disclosure contributing to the related art, may appear in the form of software products, which may be stored in a storage medium (such as an ROM/RAM, a magnetic disk or an optical disk) and include several instructions so as to enable a terminal (a mobile phone, a computer, a server, an air conditioner, or a network device) to execute all or parts of the steps of the method according to the embodiments of the present disclosure.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A driving method for a touch display substrate, comprising:
detecting a touch signal in one or more first time periods during which the touch display substrate operates, and a second time period being arranged between adjacent first time periods;
reducing frame refreshing frequency of the touch display substrate, in response to detecting the touch signal in the one or more first time periods; or
keeping the frame refreshing frequency of the touch display substrate unchanged, in response to detecting no touch signal in the one or more first time periods.

2. The driving method according to claim 1, wherein in response to detecting the touch signal in the one or more first time periods, the driving method further comprises:
detecting the touch signal continuously in the second time period after a corresponding first time period among the one or more first time periods.

3. The driving method according to claim 1, wherein an operation time period of the touch display substrate comprises one or more display phases for displaying respective frames and one or more blank phases between corresponding display phases of adjacent frames, the one or more first time periods coincides with the one or more blank phases, and the one or more second time periods coincides with the one or more display phases.

4. The driving method according to claim 1, wherein in response to detecting the touch signal in the one or more first time periods, subsequence to reducing the frame refreshing frequency of the touch display substrate, the driving method further comprises:
returning the frame refreshing frequency of the touch display substrate to normal, in response to detecting no touch signal in N consecutive first time periods after the first time period in which the touch signal is detected, where N is a positive integer.

5. The driving method according to claim 1, wherein prior to reducing the frame refreshing frequency of the touch display substrate, the frame refreshing frequency of the touch display substrate is 120 Hz; and
subsequence to reducing the frame refreshing frequency of the touch display substrate, the frame refreshing frequency of the touch display substrate is 60 Hz.

6. The driving method according to claim 1, wherein the detecting the touch signal in the one or more first time periods during which the touch display substrate operates comprises:
setting a touch enable signal (Touch EN) to a high level within the one or more first time periods, and
setting the Touch EN to a low level not within the one or more first time periods.

7-13. (canceled)

14. A driving device for a touch display substrate, comprising:
a processor; and
a memory storing therein instructions, wherein the memory is configured to implement a driving method for the touch display substrate, the driving method comprising:
detecting a touch signal in one or more first time periods during which the touch display substrate operates, and a second time period being arranged between adjacent first time periods;
reducing frame refreshing frequency of the touch display substrate, in response to detecting the touch signal in the one or more first time periods; or
keeping the frame refreshing frequency of the touch display substrate unchanged, in response to detecting no touch signal in the one or more first time periods.

15. A non-transitory storage medium storing therein instructions, wherein the memory is configured to implement a driving method for a touch display substrate, the driving method comprising:
detecting a touch signal in one or more first time periods during which the touch display substrate operates, and a second time period being arranged between adjacent first time periods;
reducing frame refreshing frequency of the touch display substrate, in response to detecting the touch signal in the one or more first time periods; or
keeping the frame refreshing frequency of the touch display substrate unchanged, in response to detecting no touch signal in the one or more first time periods.

16. The driving device according to claim 14, wherein in response to detecting the touch signal in the one or more first time periods, the driving method further comprises:
detecting the touch signal continuously in the second time period after a corresponding first time period among the one or more first time periods.

17. The driving device according to claim 14, wherein an operation time period of the touch display substrate comprises one or more display phases for displaying respective frames and one or more blank phases between corresponding display phases of adjacent frames, the one or more first time periods coincides with the one or more blank phases, and the one or more second time periods coincides with the one or more display phases.

18. The driving device according to claim 14, wherein in response to detecting the touch signal in the one or more first time periods, subsequence to reducing the frame refreshing frequency of the touch display substrate, the driving method further comprises:
returning the frame refreshing frequency of the touch display substrate to normal, in response to detecting no touch signal in N consecutive first time periods after the first time period in which the touch signal is detected, where N is a positive integer.

19. The driving device according to claim 14, wherein prior to reducing the frame refreshing frequency of the touch display substrate, the frame refreshing frequency of the touch display substrate is 120 Hz; and
subsequence to reducing the frame refreshing frequency of the touch display substrate, the frame refreshing frequency of the touch display substrate is 60 Hz.

20. The driving device according to claim 14, wherein the detecting the touch signal in the one or more first time periods during which the touch display substrate operates comprises:
setting a touch enable signal (Touch EN) to a high level within the one or more first time periods, and
setting the Touch EN to a low level not within the one or more first time periods.

21. The non-transitory storage medium according to claim 15, wherein in response to detecting the touch signal in the one or more first time periods, the driving method further comprises:
detecting the touch signal continuously in the second time period after a corresponding first time period among the one or more first time periods.

22. The non-transitory storage medium according to claim 15, wherein an operation time period of the touch display substrate comprises one or more display phases for displaying respective frames and one or more blank phases between corresponding display phases of adjacent frames, the one or more first time periods coincides with the one or more blank phases, and the one or more second time periods coincides with the one or more display phases.

23. The non-transitory storage medium according to claim 15, wherein in response to detecting the touch signal in the one or more first time periods, subsequence to reducing the frame refreshing frequency of the touch display substrate, the driving method further comprises:
returning the frame refreshing frequency of the touch display substrate to normal, in response to detecting no touch signal in N consecutive first time periods after the first time period in which the touch signal is detected, where N is a positive integer.

24. The non-transitory storage medium according to claim 15, wherein prior to reducing the frame refreshing frequency of the touch display substrate, the frame refreshing frequency of the touch display substrate is 120 Hz; and
subsequence to reducing the frame refreshing frequency of the touch display substrate, the frame refreshing frequency of the touch display substrate is 60 Hz.

25. The non-transitory storage medium according to claim 15, wherein the detecting the touch signal in the one or more first time periods during which the touch display substrate operates comprises:
setting a touch enable signal (Touch EN) to a high level within the one or more first time periods, and
setting the Touch EN to a low level not within the one or more first time periods.

26. A display device, comprising the driving device for a touch display substrate according to claim 14.

27. The display device according to claim 26, wherein the display device comprises a display, a mobile phone, a flat-panel computer, a television, a wearable electronic device or a navigator.
